(19) United States
(12) Patent Application Publication
(10) Pub. No.: US 2004/0210443 A1
(43) Pub. Date: Oct. 21, 2004

(54) Interactive mechanism for retrieving information from audio and multimedia files containing speech

(76) Inventors: Roland Kuhn, Santa Barbara, CA (US); Jean-Claude Junqua, Santa Barbara, CA (US); Patrick Nguyen, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/417,870

(22) Filed: Apr. 17, 2003

(51) Int. Cl. G10L 11/00

(52) U.S. Cl. 704/276

(57) ABSTRACT

The system assesses a measure of quality associated with the user's query, which may be based on the query itself or upon the results returned from a first search space. If the measure of quality is low, the system accesses one or more second knowledge sources and retrieves intermediate results that belong to the vocabulary of the first search space. A second query is then constructed using the intermediate results, and based on further input from the user as needed. The second query is then used to search the first search space with results returned to the user.

### FIELD OF THE INVENTION

The present invention relates generally to information retrieval. More particularly, the invention relates to an information retrieval system that assesses the degree of query and result retrieval quality in several dimensions and then engages the user in an interactive dialogue to resolve any quality issues. The system detects when a sufficiently low degree of quality exists, such as when the query employs a term that is not within the primary search space vocabulary, or when a search term has alternate meanings. Upon detecting such a quality issue, the system consults an auxiliary search space to formulate a revised query that is then submitted to the primary search space for information retrieval.

### BACKGROUND OF THE INVENTION

There has been a huge increase in the volume of stored audio and multimedia data, leading to a demand for effective mechanism allowing retrieval of desired information. Where the files contain speech, an automatic speech recognition (ASR) system can be used to transcribe the speech data into word sequences. Subsequently, users formulate queries whose words are matched against the words in the text generated from each audio file, with the audio files yielding the closest match then being returned to the user.

Several problems can arise with such state-of-the-art audio indexing systems; these problems are well described in a recent technical paper, “An Experimental Study of an Audio Indexing System for the Web” (B. Logan, et al., Int. Conf. Spoken Language Processing, October 2000, Beijing, China, V. 11, pp. 676-679). Many of the problems encountered are caused by so called “out-of-vocabulary” (OOV) words. Note that it is most efficient to define a fixed vocabulary for the ASR system before it carries out recognition on a large set of audio files. The recognition vocabulary is often large (e.g., 60,000 words) but it cannot contain all the words that may occur in audio files or in user queries. For instance, there is no way to predict in advance which names of persons or companies will occur in news broadcasts. So, if one is designing an ASR system to be run on audio news files for the next six months, it is inevitable that some names that will be spoken will be missing from the system's vocabulary.

Consider a user who types “Malvo” into a state-of-the-art system that has been indexing news broadcasts with an ASR system whose vocabulary was established in June 2002. Even though there have been thousands of news broadcasts containing this name since the arrest of two suspected “Washington snipers”—one of them named John Lee Malvo—in late October, 2002, the system will not find any of them. The reason: “Malvo”, a very unusual last name, will not be in the system's recognition vocabulary, and will thus not appear in the transcriptions. The ASR transcription system is likely to generate a similar-sounding word or sequence of words, e.g. “Volvo”, “Marlborough”, “although” or “mall go.”

Another problem, unrelated to ASR transcription errors, occurs where the user formulates a query that does not match a desired transcription, even though every word of the transcription was correct. For instance, the user may fail to retrieve a relevant audio clip because his or her choice of words is not found within the transcription vocabulary. (The user enters “Flu symptoms” and fails to retrieve an audio clip containing the words “signs of influenza”.) The user may likewise fail to retrieve relevant results because of misspelling. (The user types “cheny” and is unable to retrieve clips about U.S. Vice President Dick Cheney.) As will be described in more detail below, the present invention addresses all of these problems by intelligently analyzing the search results and interacting with the user.

### SUMMARY OF THE INVENTION

Conventional systems provide little guidance to users who have typed in a query; if search results are unsatisfactory, they are generally given few hints as to how to reformulate it to obtain better results. The present invention provides ample guidance for query reformulation to the user. For instance, the present invention can compare its recognition vocabulary with the words in the user's query and can therefore determine if the query contains out-of-vocabulary words. It can be provided with a priori knowledge such as dictionaries of synonyms and common types of misspellings (e.g., letters that are often substituted for each other because they are neighbors on the keyboard). The invention can also use statistical knowledge derived from text corpora (e.g., recent news stories from the print media). Thus it can provide alternatives to the user, each containing words and phrases that are in the recognition vocabulary. The user's choices will determine the final query.

In a presently preferred form, the invention deals with 3 different problems, each of which may contribute to a mismatch between a user query and the primary search space to which it is applied. If one or more of these problems is detected by the system, and is sufficiently serious, the system will formulate search strategies by which alternatives are provided to the user for further interaction. In this presently preferred form, three different levels of quality are potentially considered: type 1 quality associated with performance of the recognition system; type 2 quality associated with the meaning of the user's query; and type 3 quality associated with the manner in which the query and the recognition system interact.

Type 1 quality issues can arise, for example, where the recognizer had low confidence during the recognition process. Type 1 quality issues arise independent of any query a user may later submit to the system. Type 2 quality issues can arise, for example, where the user's query is ambiguous. Type 3 quality issues can arise, for example, where a query term lies outside the vocabulary that existed when the recognition system created the index of an audio file.

Most state-of-the-art speech recognition systems can provide numerical estimates of the confidence associated with the word sequences assigned to a given segment of speech. For instance, a segment of a news story spoken calmly by an adult speaking into a high-quality microphone in a quiet environment would tend to generate a word transcription most of whose segments were assigned high confidence, while garbled sentences shouted by children in a noisy environment would tend to generate transcriptions with many low-confidence intervals. Thus, an information retrieval system operating on transcriptions of speech produced by a speech recognition system may have fairly reliable information about the likelihood of type 1 problems in a given segment of a given transcription. Clearly, type 1 problems are independent of the query terms chosen by the user.

Type 3 problems, by contrast, are due to words in the user's query that are not in the ASR lexicon. The ASR lexicon will be known to the retrieval system in advance, but obviously the words in the query are only known when the query is entered. Thus, type 3 problems can be often detected when the query is entered (before the search is even attempted); in cases of partial intersection between the ASR lexicon and the user query, however, the severity of the problem may only be fully known after search has been attempted.

Finally, type 2 problems are typically detected AFTER search has been attempted. One example would be if the query is ambiguous. For instance, the user types in “aids” and the system retrieves documents concerned with the disease, along with other documents concerned with charity (most of them unrelated to disease). Note that this query would NOT have been ambiguous if applied to a medical database, where the disease-related meaning of “aids” would predominate. Thus, this type of problem is typically best analyzed by looking at the results of the query. Detection of ambiguous results may be performed using suitable techniques such as Latent Semantic Indexing to construct a “document space” and a distance measure associated with it, such that documents that are near each other in the space have similar semantic content. In one embodiment of the invention, the distance between documents returned by a query is measured. If the average distance between them exceeds a given threshold, the query is judged to be ambiguous (type 2 problem) and is assigned a low quality score.

In accordance with one aspect of the invention, a method for retrieving information from a first search space based on a user query is provided. The search space has an associated first vocabulary. The method entails searching based on the user query and retrieving first results from the first search space. A measure of quality is then assessed by the system at one or more levels. If these measures of quality correspond to predetermined low quality ranges, then a number of additional steps are performed, depending on the nature and type of the quality issue or issues. Otherwise, if the measures of quality do not correspond to predetermined low quality ranges, then the first results are simply supplied to the user in response to the query.

According to another aspect of the invention, if a measure of quality corresponds to a predetermined low quality range, the system conducts a series of additional exploratory searches, based on a set of generated query hypothesis, through a second search space or a second knowledge source to assemble a set of intermediate results. The second knowledge source can exist in several informational domains, which can be explored sequentially or in parallel (e.g., knowledge of typing errors, knowledge of pronunciation and/or recognizer errors, synonyms of query terms, knowledge of words that are semantically related to query terms, and so forth). The second knowledge source can also include text corpora that span a vocabulary that extends beyond the vocabulary of the first search space.

The results of these exploratory searches are then analyzed by intersecting them with the vocabulary of the first search space. Exploratory search results that are found within the vocabulary of the first search space are identified and at least a portion of these are returned to the user in the form of a prompt or series of prompts. Thereafter, the query is reformulated, or a second query is constructed based on the user's response to the prompts, and this reformulated or second query is then used to retrieve second results from the first search space. These second results are then supplied to the user.

In addition to exploiting the second knowledge source to resolve quality, the system can also advantageously exploit the first search space, under certain conditions, by using its knowledge of the language model and acoustic models used to develop the first search space. When ASR is used to conduct an index of an audio or multimedia file, each transcribed word in the index has an associated recognition score. The quality analysis module of the invention uses this recognition score to identify hits that would otherwise be ignored. The following example explains how system works in this regard.

In this example, the automatic speech recognition system has failed to properly recognize a term (due to high background noise or other poor recognition conditions). The word “Malvo” has been recognized as “mall go.” The word Malvo is not in the lexicon of the ASR system. In addition, assume that the word Marlborough was recognized and is in the lexicon. The user now submits a query for the term “Malvo.” The recognition scores associated with “mall go” are low; the recognition score associated with “Marlborough” is high.

If the assigned recognition score represents low recognition confidence, then phonetically similar terms that exist in the first search space are identified and used to construct the prompt for user decision. Thus, words that are phonetically similar to “mall go” would be used to construct a prompt for user selection. On the other hand, if the score represents high recognition confidence, then the associated word is not returned or used to construct the prompt. Thus the word “Marlborough” is not used to generate phonetically similar words as prompts.

Using the low confidence hits may seem counterintuitive, at first. However, it is the low confidence hits that likely correspond to poor ASR performance causing an out-of-vocabulary problem. For example, if the ASR misrecognizes “Malvo” as “mall go,” and does so with low confidence (low recognition score), the system will infer that a better ASR recognition might have generated “Malvo.” Hence, the low confidence “mall go” hit may well be a desired “Malvo” hit.

In a similar fashion, the system also exploits other levels of quality, including language model quality (whether the sentence or phrase perplexity is high or low) and semantic quality (whether the meaning ambiguity is high or low). Language model quality would be low, for example, where the ASR system generates a sentence or phrase that does not obey grammar rules. Semantic quality would be low, for example, where the ASR system generates a sentence or phrase where there are several possible meanings, or where the meaning simply is not clear.

As with the case of acoustic quality, the system reacts to these additional sources of quality by identifying the hits with low quality and using them to construct the user prompt.

For a more complete understanding of the invention, its objects and advantages, refer to the remaining specification and to the accompanying drawings. Upon such review, further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating the basic components of an information retrieval system in accordance with the invention;

FIG. 2 is a flow chart diagram useful in understanding the presently preferred method of the invention;

FIG. 3 is a flowchart diagram illustrating one presently preferred embodiment of the invention;

FIG. 4 is a sequence diagram depicting an alternate embodiment for formulating the user prompt based on information gleaned from the second search space and from quality measures associated with the first search space; and

FIG. 5 is a block diagram illustrating a presently preferred embodiment of the invention in greater detail.

### DETAILED DESCRIPTION OF THE PREFERRED EMBODIMENTS

The following description of the preferred embodiment(s) is merely exemplary in nature and is in no way intended to limit the invention, its application, or uses.

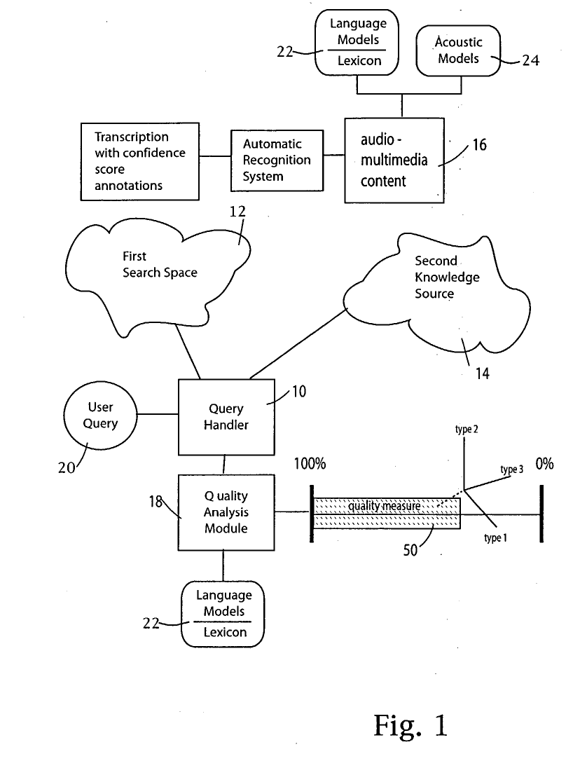

Referring to FIG. 1, an overview of some of the principles of the invention will now be described. A query handler 10 is configured to access a first search space 12. Query handler 10 is also configured to access a second search space or second knowledge source 14. Typically, the second knowledge source 14 will contain vocabulary entries not found in the first search space 12. The second knowledge source can lie across several databases or data stores, as the later examples will show. The second knowledge source can also overlap with the first search space, whereby quality information about the first search space is used to identify content in the first search space that may be used to generate prompts to the user. To illustrate how the invention may be deployed, an audio indexing system will be described. Of course, the invention may be used to conduct searches of data sources other than those linked to audio or multimedia content.

In an exemplary embodiment, the first search space may be text generated using an automatic speech recognition (ASR) system upon a collection of speech data, such as news broadcasts, for example. As is often the case, the ASR system was designed with a certain vocabulary or lexicon of finite size. Words that are not in the ASR lexicon will therefore not become part of the first search space text corpus-even though those words did occur in the speech data. In contrast, the second knowledge source is not so limited. It can potentially contain every word in the language, including proper nouns, abbreviations and acronyms.

Audio Indexing Systems

In an audio file or multimedia file indexing system, for example, the first search space 12 may contain an index that links to audio or multimedia content 16. This index is constructed using ASR upon the audio/multimedia content. The second search space may contain text news stories and other content, for example, that was not generated using ASR.

In an exemplary audio or multimedia data mining application, an audio indexing system is used to analyze the audio for multimedia content 16. Speech recognition software is used to analyze the entire audio or multimedia content data store and then produce a searchable index of content-bearing words and their locations within content 16. Creating an index in this fashion is quite important because the audio content or multimedia content exists in a binary format in its native state and is not otherwise readily searchable.

Currently there are two main approaches to audio mining: text-based indexing and phoneme-based indexing. Text-based indexing Uses large vocabulary continuous speech recognition to convert speech data in the audio or multimedia content file into text. The indexing system then identifies words within its dictionary that match the words generated during recognition. Understandably, the dictionary associated with the continuous speech recognition system has a finite number of entries and these entries define the metes and bounds of the small vocabulary search space 12.

Phoneme-based indexing does not convert speech into text, but instead converts speech into a set of recognized sound units (e.g., phonemes, syllables, demi-syllables, and so forth). The phoneme-based indexing system first analyzes and identifies sounds in a piece of audio content to create a phonetic-based index. It then uses a dictionary of several dozen phonemes to convert a user's search term to the correct phoneme string. The query handling system then looks for search terms in the index, based on the phonetic representation of the user's input query. Phoneme-based systems are typically considerably more complex than text-based systems. Moreover, phoneme-based search can result in more false matches than text-based searches. This is particularly true for short search terms, because many words sound alike or sound like parts of other words.

Analyzing Quality

As will be more fully explained herein, the query handler 10 of the present invention includes an quality analysis module 18 that will automatically assess when a user's query 20 is likely to produce poor or ambiguous results. Such poor results can occur for a variety of reasons, due to quality variations at a variety of different levels or quality variations of a variety of different types. In this description, the following nomenclature is adopted for describing different types of quality: type 1 quality associated with performance of the recognition system; type 2 quality associated with the meaning of the user's query; and type 3 quality associated with the manner in which the query and the recognition system interact.

Type 1 quality issues can arise, for example, where the recognizer had low confidence during the recognition process. For example, if the audio file being indexed is a live news broadcast, there may be portions of the broadcast where background noise degrades the intelligibility of what is being said. The recognizer may be capable of performing recognition on such degraded passages, but such recognition may be at a lower confidence level. Type 1 quality issues arise independent of any query a user may later submit to the system.

Type 2 quality issues can arise, for example, where the user's query is ambiguous. Typing and spelling errors are errors of type 2 quality. In addition, use of words having multiple meanings can also give rise to type 2 quality. Two sentences resulting from recognition might be: “the aids epidemic has grown worse . . . ” and “the help desk staff often aids users in use of the computer system . . . ” In this case the word “aids” is ambiguous.

Type 3 quality issues can arise, for example, where a query term lies outside the vocabulary that existed when the recognition system created the index of an audio file. The user's query may be completely clear; and the recognition system may have operated perfectly; and yet the system is still unable to retrieve useful results because the query term is out of vocabulary.

The quality analysis module 18 analyzes these different types of quality so that the system can take appropriate action. Within each type, quality can be quantified in terms of binary or discrete quality states, or in terms of a quality range (0% to 100% quality scores). The system will respond in predefined ways, based on the degree and type of quality encountered. Although quality analysis can be approached in a variety of ways, the following provides further description of a presently preferred approach.

Recall that type 1 problems arise where the automatic speech recognition (ASR) accuracy is degraded. Such problems may be unavoidable: for instance, recognition accuracy will inevitably be lower for segments of the audio file containing extraneous noise. State-of-the-art ASR systems can provide confidence estimates to accompany segments of speech; the higher the numerical confidence value assigned to a speech segment, the more likely it is that the words in that time segment were accurately recognized. Suppose that the user has typed in a query that is not ambiguous and contains many keywords that were actually spoken in many of the audio files in the database, and that these keywords are in the ASR system's lexicon. However, many of the audio files contain low-confidence regions. This is the case where the problem is entirely of type 1. In this case, the invention can help the user by:

1. preferentially supplying the user with the files or file segments where the keywords in the query were recognized with high confidence;

2. giving the user the choice of listening to files or file segments where these keywords were recognized with lower confidence, while warning the user that some of the results returned may be spurious;

3. giving the user the choice of listening to files or file segments where these keywords were NOT recognized, but where either:

i. words, word sequences, or phoneme sequences potentially acoustically confusable with the keywords were recognized with low confidence;

ii. words semantically associated with the keywords occurred.

Type 3 problems occur when there is little or no intersection between the keywords in the user's query and the ASR lexicon. These cases can be dealt with as in 3. ii. in the preceding paragraph. That is, words semantically associated with the user query keywords are generated and intersected with the ASR Lexicon to generate a list of words semantically close to the query keywords, and in the ASR lexicon. In the preferred embodiment, a list of such new keywords is presented to the user, who may then select some or all of them; those selected constitute a new query. Ways in which the set of words Q in a user query can generate a new set of keywords N include, but are not limited to, the following:

synonyms of words in Q may be put on the list N (using a dictionary of synonyms);

for each word in Q, take a large text corpus (e.g., a collection of recent news stories) and put on the list N any word that occurs within a window of W words preceding and following the given word;

using Latent Semantic Analysis (LSI) or a similar technique, build a semantic space of words and put on the list N any word that is within a given distance of a word in Q.

As is well known in the field of information retrieval, it would be advisable to remove from both N and Q any so-called “stop words” while performing these computations. A stop word is a word like “and” or “but” that has high frequency in the language but occurs with fairly even frequency across documents, and thus has little information content.

Type 2 problems are related to ambiguity in the documents returned from a query. Recall that in the preferred embodiment, a set of documents returned by a query may be judged by the system to be ambiguous if the distance between documents in the set, according to a measure of semantic closeness, exceeds a threshold. In the preferred embodiment, the system may be able to resolve this problem by grouping the documents returned by the query into clusters, with documents in each cluster being close to each other in the semantic space.

This may be done by using the K-means algorithm or a similar method from the pattern recognition literature. From each cluster, a set of keywords characterizing that cluster may be extracted, such that the keywords characterizing a cluster have high frequency in that cluster relative to their frequency in the other cluster(s). The user may then be asked to choose between sets of keywords.

An example would be a user who enters the ambiguous query “aids research”. Suppose that the system detects large semantic distances between the documents returned, and then resolves them into two clusters. Keywords characterizing cluster 1 are “disease”, “viral”, and “hospital”; keywords characterizing cluster 2 are “philanthropist”, “charity”, and “university” (a typical document in cluster 2 might have the headline “Bill Gates aids research by giving university $50 million”). The system displays the two groups of words to the user, asking him or her to click on the group which best expresses his or her intention. The documents in the cluster thus chosen are then provided to the user.

Exploiting Knowledge of Acoustic and Language Models

The quality analysis module 18 may optionally have knowledge of the language models and ASR lexicon upon which the indexing system is based. These are supplied as language model 22 and its associated ASR lexicon. The language model 22 and associated lexicon is also associated with the audio-multimedia content 16, as illustrated. Also associated with content 16 are the acoustic models 24 used by the ASR system. This knowledge is exploited by the system in determining the degree of quality. As will be further explained, this quality information is used both to determine whether the second search space should be mined and also to assess whether query results returned from the first search space should be returned to the user.

The presently preferred quality analysis module 18 operates on one or more quality scores associated with each search word, term, phrase, sentence and/or string within the user's query. For example, if during audio indexing, a particular word or term has a high recognition score, that term will be included as a searchable term in the index file of the search space. In such case, the degree of quality for that word or term will be high. However, the ASR process is also likely to generate index terms that are actually the result of misrecognition. These will typically have much lower recognition scores, and hence a lower degree of quality.

The quality analysis module (FIG. 1) is designed to interpret a quality range associated with the entries found within the search space 12. User query terms that yield results having associated high quality levels are simply used to query the search space 12; whereas, terms that fall within a predefined lower quality range are subject to further processing as will be more fully explained below.

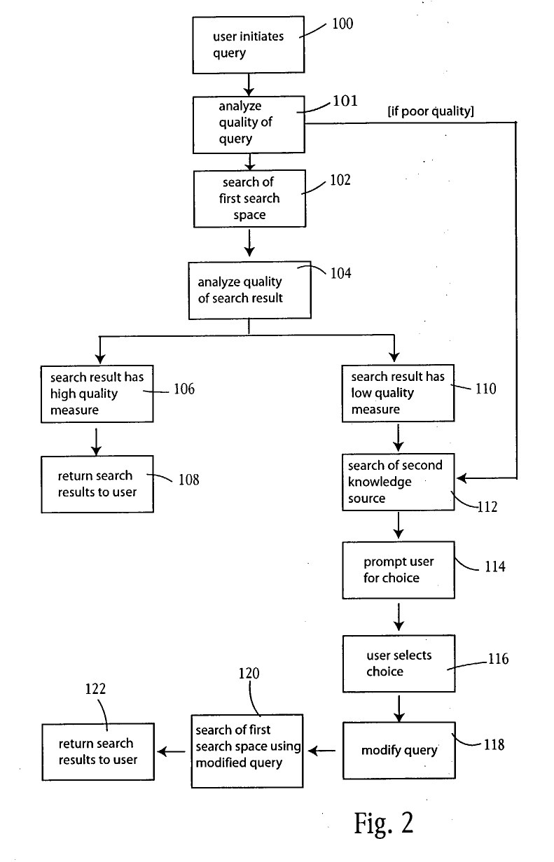

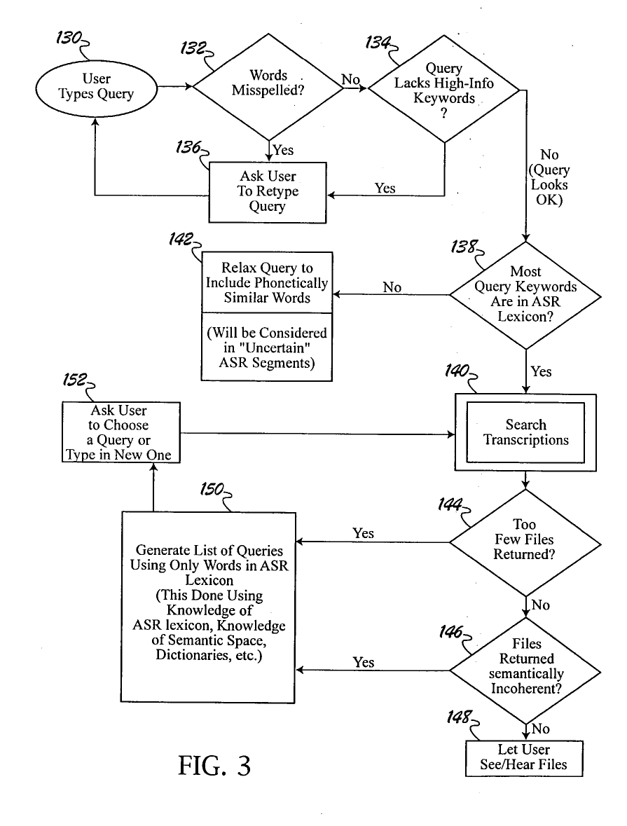

Refer now to FIG. 2 for an overview of how information is retrieved. A more detailed view of a preferred implementation will then be shown and described in connection with FIG. 3. Referring to FIG. 2, the procedure begins at step 100 with a user initiated query. The system then assesses a measure of quality associated with the user query. This assessment is done in two ways (steps 101 and 104 discussed below). First, the quality of the query itself is tested at 101, to determine if the query uses out-of-vocabulary words or contains other errors, such as spelling errors. If the query cannot proceed (due to out-of-vocabulary usage or other query defects) the user may be prompted to enter a new query. Otherwise, the query handler 10 (FIG. 1) applies the user query to conduct a search of the first vocabulary search space associated with the indexed files (step 102). The user's query may employ words or search terms for which a comparatively low level of quality exists. This low quality may not have been enough to fail the quality test at step 101. Thus, at step 104 the quality level of the user's input query is assessed and then the results are provided to the user according to one of two processes, depending on the degree of quality.

The quality of the user's query can be assessed in two ways. First, the system can compare the words used in the query against the words in the ASR lexicon. If a significant proportion of those words fall outside the lexicon (i.e., an out-of-vocabulary condition exists) then the query is deemed to be of low quality. In an exemplary application, the low quality threshold may be established by counting the number or percentage of OOV words and also considering the usefulness of the remaining query terms. If a first predetermined percentage of OOV words are used; and if the remaining terms are of low discriminative value (e.g., noise words such as articles, prepositions and very commonly used words) then the low quality threshold will be deemed to have been met. On the other hand, if the remaining words are of high discriminative value the low quality threshold will not be deemed to have been met, unless a higher predetermined number of OOV words are present. The predetermined numbers may be readily determined by empirical techniques.

Alternatively, or in addition, the user's query can be assessed based on the search results it generates. If the search results are poorly clustered in semantic space then a low quality may also be inferred.

If the user's query generates search results for which the terms have a high degree of quality, as indicated at 106, the results of that query are simply returned to the user at 108. These results may correspond to audio indexing records, which may in turn server as pointers to the original audio or multimedia content.

On the other hand, if the user's query produces search results that contain words or phrases having a low quality measure, a different process is followed as indicated at step 110. When a low quality measure is detected, (such as where the system returns too few results, or semantically incoherent results) the word or terms associated with that low quality measure are assumed by the system to be unreliable. In this case, the system will use other resources, such as a search of a second knowledge source (which can be one or more sources) (step 112) to develop other search terms or search criteria that are then provided back to the user in a prompt requesting the user to select which results from the second knowledge source best suit the user's inquiry.

The user is thus prompted at step 114 and supplies his or her selection at 116. Based on the user's selection, the original query is modified at step 118 and a new search is submitted, based on the modified query, of the first vocabulary space (step 120). Finally, the results of the modified query are returned to the user at step 122.

A presently preferred implementation of the system is illustrated in FIG. 3. The user enters a query at 130 by typing or other suitable means. The system checks at 132 to determine if any words in the user's query have been misspelled. If not, the system then examines the query to determine if it is otherwise deficient, as by lacking any high information keywords. A query containing only prepositions and articles (of, with, the, a, an, etc.) would lack sufficient keywords and would thus be rejected, by asking the user to retype the query at 136.

If the query looks okay, the system tests at 138 to determine if most of the keywords are in the lexicon or dictionary of the recognition system. If they are, the transcription is searched at 140. If a sufficient number of keywords are not found in the lexicon, the system relaxes the query to include phonetically similar words at 142. These phonetically similar words will be considered in “uncertain” automatic speech recognition (ASR) segments. The relaxed query is then used to search the transcriptions at 140.

After the search results are received, they are examined at step 144. If too few results are returned, a subsequent test is performed to determine if the files or results returned are semantically incoherent at step 146. If they are not, the user is shown the returned results at step 148. If too few files are returned at 144, or if the files returned are semantically incoherent, the additional information extraction process at 150 is performed.

At step 150, the system generates a list of queries using only words in the ASR lexicon. This is done using knowledge of the ASR lexicon, knowledge of the semantic space, auxiliary dictionary sources, other text corpora, and the like. The user is then asked at step 152 to choose a query from the information generated in step 150, or to enter a new query, if none of the proposed information is deemed suitable. The user's selection, or new query, is then submitted to the search transcription process 140, as illustrated.

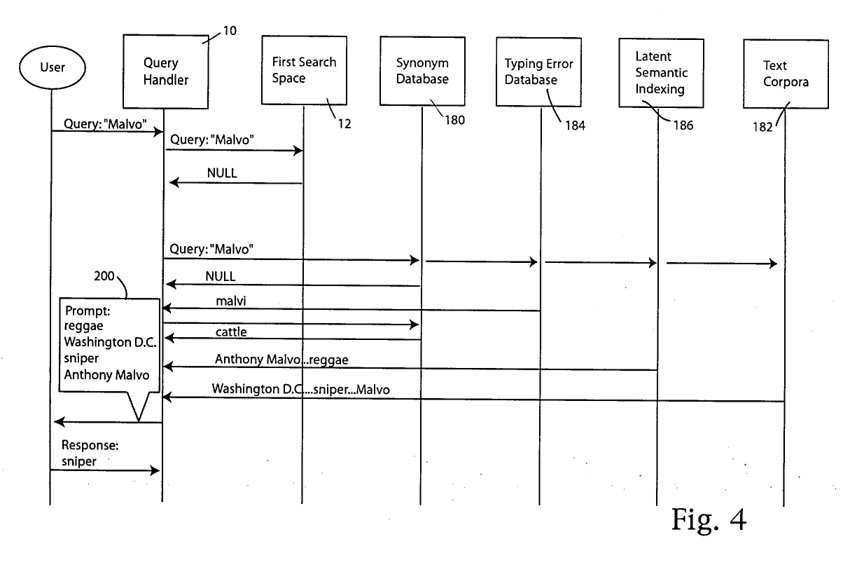

While all of the processes illustrated in the foregoing examples may be implemented using a single system, distributed systems employing parallel processing are also possible. FIG. 4 illustrates one such distributed system for implementing the functionality of step 112 in parallel processes. While illustrated embodiment performs many of its searching operations in parallel. It will be recognized, however, that these searching operations may be implemented in a distributed system that conducts operations serially, or in serial-parallel combination, as well.

The example illustrated in FIG. 4 is based on a prominent news event that occurred during the summer of 2002, during which a series of initially unsolved sniper-fire murders in the Washington D.C. area were ultimately attributed to two suspects, one by the name of John Lee Malvo.

Referring to FIG. 4, the User submits the query, “Malvo,” to the query handler 10. Query handler 10, in turn, submits the query, “Malvo,” to the first search space 12. In this example it is assumed that the word “Malvo” is not within the vocabulary of the first search space. Thus, the query of the first search space returns a NULL value to query handler 10.

Query handler 10 interprets the NULL return value as a condition of low quality. In this case, the quality is 0% as no hits are returned. Query handler 10 then submits the query, “Malvo,” to the second search space 14. In this example the second search space 14 comprises a synonym database 180, a text corpora 182, a typing error database 184 and a corpora of mapped close words 186 developed using latent semantic indexing. Other sources of information may also be used, of course. In the present example, query handler 10 sends its request to all entities within the second search space in parallel, that is, substantially simultaneously. However, this is not a requirement. Some embodiments of the query handler may invoke searches of different entities within the second search space at different times or in different sequences, depending on the results returned from searching.

In this example, it will be assumed that there is no entry in the synonym database for the term, “Malvo,” hence the synonym database 180 returns a NULL value to query handler 10. Typing error database 184 contains knowledge of the QWERTY keyboard layout, and this is able to construct and identify a word, “malvi,” that could represent a likely mistyping, due to the fact that the letters ‘o’ and ‘i’ are adjacent one another on the QWERTY keyboard.

Meanwhile, the text corpora 186, developed using latent semantic indexing, find a hit for the term, “Malvo,” corresponding to a reggae singer by the name of Anthony Malvo. Words in the text corpora 186 may be rated according to frequency of use. The word reggae occurs fairly infrequently across the entire text corpus; whereas common articles and prepositions (“the,” “an,” “of,” “at,” “with”) occur and may be treated as “noise.” Because “reggae” occurs infrequently, it is useful as a semantic flag to identify a potentially relevant topic (reggae music) associated with Anthony Malvo. The name “Anthony” is similarly useful as a semantic flag. The terms, “Anthony Malvo” and “reggae” are returned to the query handler 10.

Meanwhile, the text corpora 182 are also searched for presence of the term “Malvo.” In the illustrated embodiment, text corpora 182 are constructed from text extracted from text-based news articles. Whereas the term “Malvo” did not appear in the vocabulary of the first search space (because the ASR system could not recognize it for indexing, or because the ASR system was configured before the term “Malvo” was present in any audio or multimedia content), the term Malvo does appear in the vocabulary of text corpora 182. Text corpora 182 are developed from text entered through keyboard entry and are thus likely to have many instances of words appearing in breaking news stories.

Text corpora 182 return semantic flag words that occur in close sentence proximity to the word Malvo. In other words, text corpora 182 return those frequently occurring words that appear in phrases, sentences or paragraphs with the text corpora that also include the word “Malvo.” In this case, the words “Washington, D.C.,” “sniper,” and “Malvo” are returned to the query handier 10.

The query handler 10 may be configured to use some or all of the results returned from the second search space in conducting additional searches of the second search space. For example, the term “malvi” returned from the typing error database 184 may be submitted back to the other entities for further searching. In this example, the term “malvi” is resubmitted and the synonym database returns information that “malvi” is a type of “cattle.”

After collecting all of the returned results from one or more searching iterations of the second search space, the query handler 10 performs an intersection operation of the returned results and the vocabulary of the first search space. It constructs a prompt to the user, illustrated at 200, that contains the returned results, but that excludes any results that are not within the vocabulary of the first search space. In the present example, it has been assumed that the terms “malvi” and “cattle” are not within the vocabulary of the first search space. Thus, these terms are not offered to the user as part of the prompt 200. Of course, the term “Malvo” is not in the vocabulary either. However, the system does return the phrase “Anthony Malvo” because, in this example it has been assumed that “Anthony” does appear in the vocabulary of the first search space. Because “Anthony” is part of a proper name, the system prompt couples “Anthony” with “Malvo” even though “Malvo” is not in the vocabulary.

Upon receiving and reviewing the prompt 200, the user selects the topic “sniper” and that term is used to either reformulate the user's original query or to construct a new query that is submitted by the query handler to the first search space.

Exploiting the Acoustic, Language and Semantic Models

In the preceding example, it was assumed that the initial query submitted by query handler 10 to the first search space 12 retrieved a NULL hit. However, in some instances it is possible that the query handler will return results from the first search space, even though the term “Malvo” was not literally found. When the ASR system was used to construct an index of an audio or multimedia file, each transcribed word in the index may be assigned an associated recognition score. In addition, the text may be analyzed to establish poor language model quality (where the sentence or phrase perplexity is high) and poor semantic quality (where the meaning ambiguity is high). This information, in combination with acoustic confidence measures, is used to label the indexed words. As previously discussed, language model quality would be low, for example, where the ASR system generates a sentence or phrase that does not obey grammar rules. Semantic quality would be low, for example, where the ASR system generates a sentence or phrase where there are several possible meanings, or where the meaning simply is not clear.

The query handler 10 may be configured to exploit the acoustic, language and semantic quality, to extract hits from the first search space that do not literally match the input query. In this regard, the query handler 10 operates as follows.

If the assigned recognition score represents low recognition confidence, then phonetically similar terms that exist in the first search space are identified and used to construct the prompt for user decision. On the other hand, if the score represents high recognition confidence, then the associated word is not returned or used to construct the prompt. Using the low confidence hits may seem counterintuitive, at first. However, it is the low confidence hits that likely correspond to poor ASR performance causing an out-of-vocabulary problem. For example, if the ASR misrecognizes “Malvo” as “mall go,” and does so with low confidence (low recognition score), the system will infer that a better ASR recognition might have generated “Malvo.” Hence, the low confidence “mall go” hit may well be a desired “Malvo” hit. The system may use language model and semantic model information in the same fashion.

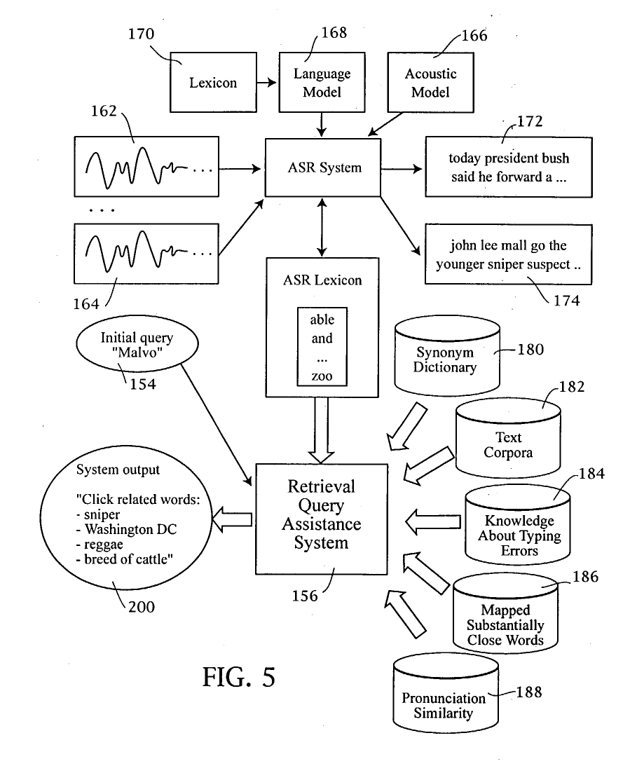

FIG. 5 presents another view of the previous example of FIG. 4. FIG. 5 illustrates how the invention may be implemented as a retrieval query assistance system. The user initiates a query by typing “Malvo” into the retrieval query assistance system 156 that is configured according to the present invention. Note that the initial query 154 may be typed, or entered through other means such as by spoken input. In the example of FIG. 5 it is assumed that the query assistance system accesses a database of news broadcasts that have been indexed using an automatic speech recognition system (ASR system) 160. News broadcasts are fed to the ASR system 160 as audio files 162 and 164, for example. The ASR system then uses its set of acoustic models 166 as well as a language model 168 and associated dictionary or lexicon 170 to convert the spoken sound files into sound unit data. Depending on the design of the ASR system, the sound unit data may be text data or phoneme data, or some other form of ASR recognition output. In the illustrated example of FIG. 4, the ASR system produces text output. In the illustration, two different text files are illustrated at 172 and 174, corresponding to the text input files 162 and 164.

In the illustrated example, sound file 164 actually corresponds to the spoken text “John Lee Malvo the young sniper suspect.” However, the name Malvo is a very unusual last name and is not found in the ASR system's recognition vocabulary (lexicon 170). Because the name does not appear in the vocabulary it will not appear in the transcription at 174. Instead, the recognition system generates a similar-sounding word or sequence of words. In this case the transcription reads “John Lee mall go the young sniper suspect.” Other spoken instances of the name Malvo might generate other similar-sounding transcriptions, e.g., “Volvo,” “Marlborough,” “although,” and so forth. Thus, in this example, the name Malvo represents an out-of-vocabulary word that is not found within the ASR system's recognition vocabulary.

When the user types in “Malvo,” the system ascertains that this word is not in the ASR lexicon. It then consults a synonym dictionary 180 and fails to find an entry for Malvo. However, using knowledge about typing errors (e.g., vowels are often substituted for other vowels) the system tries “Malvi” and discovers that this is a breed to cattle. The knowledge of typing errors are stored in a suitable data store such as data store 184.

In addition, the system also searches for the word Malvo in a separate database of text corpora, shown generally at 182. This database of text corpora may represent a plurality of different sources of text information that is available from the internet or other sources. The text corpora need not represent text that was generated using an ASR system. On the contrary, much of the text corpora available on the internet is originally generated as text data (news stories, articles and the like).

In the present example, the word “Malvo” is likely to occur numerous times, because of the large number of stories that have recently appeared using this word. The system uses standard information retrieval techniques to find words and phrases with an unexpectedly high frequency in this text. Such words might include “sniper,” “rifle attacks,” “Washington, D.C.” et cetera. Using such search techniques the system may also find text related to other instances of Malvo that do not relate to the sniper suspect. For example, the system might find the reggae musician, Anthony Malvo, in text sources containing different unexpectedly high frequency words such as “reggae,” “music,” and “CD.”

The system will find the high frequency words associated with the search term Malvo, in question, and will present those to the user as at 200. The user is prompted to select which, if any, of the high frequency words correspond to the topic he or she is interested in. If the user selects “sniper” and “Washington, D.C.” the user will obtain audio clips related to John Lee Malvo, rather than Anthony Malvo or cattle.

The text corpora 182, by their very nature, are likely to have a much larger vocabulary than the vocabulary of the ASR system. Thus the text corpora represent a rich source of possible additional search terms that can be used to retrieve suitable audio clips from the system. However, not all terms retrieved from the text corpora may be found in the vocabulary of the ASR system. The retrieval query assistance system 156 has knowledge of the ASR system's vocabulary and is thus able to select for presentation to the user only those terms that are found within the ASR system's vocabulary. If, for example, the word “cattle” is not found in the ASR system's vocabulary, then the user would not be presented with the breed of cattle option at 200.

While the text corpora 182 represent a rich source of information upon which the original query can be expanded, embodiments of the invention are also envisioned where other sources of information may be used. These may include data stores of mapped substantially close words 186 and data stores of pronunciation similarity 188.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for retrieving information from a first search space based on a user query, the search space having an associated first vocabulary, comprising:
assessing a measure of quality associated with the user query;
if the measure of quality corresponds to a predetermined low quality level then performing the following steps (a) through (d):
(a) searching based on the user query and retrieving intermediate results from a second knowledge source that: (i) have a predetermined proximity relationship with the first results and (ii) belong to the first vocabulary;
(b) supplying at least a portion of said intermediate results to the user and prompting the user to select at least one of said supplied portion of said intermediate results;
(c) constructing a second query based on said intermediate results and using the second query to retrieve second results from the first search space;
(d) supplying the second results to the user;
otherwise, if the measure of quality corresponds to a predetermined high quality range then supplying the first results to the user.

2. The method of claim 1 wherein said step of assessing a measure of quality associated with the user query comprises searching the first search space based on the user query, retrieving first results from the first search space and assessing the quality of the first results.

3. The method of claim 1 wherein said step of assessing a measure of quality associated with the user query comprises comparing the user query with a vocabulary associated with the first search space.

4. The method of claim 1 wherein said first search space contains information from speech data and wherein said second knowledge source contains information about pronunciation similarity.

5. The method of claim 1 wherein said first search space contains information from speech data and wherein said second knowledge source contains information about sound unit confusability.

6. The method of claim 1 wherein said first search space contains information from speech data and wherein said second knowledge source contains at least one text corpus.

7. The method of claim 1 wherein said first search space contains information from speech data and wherein said second knowledge source contains semantic information.

8. The method of claim 1 wherein said first search space contains information from speech data having an associated language model and wherein said assessing step is performed by using said language model to score the retrieved first results.

9. The method of claim 1 wherein said first search space contains information from speech data annotated according to an associated language model to reflect the degree to which said speech data conforms to the language model and wherein said assessing step is performed by assessing how closely the first results conform to the language model.

10. The method of claim 1 wherein said first search space contains information from speech data annotated according to a set of associated speech modes to reflect the confidence with which the information corresponds to the speech data and wherein said assessing step is performed by assessing said annotated speech data.

11. A method for retrieving information from a first search space that was generated using automatic speech recognition upon speech data using a lexicon of predefined vocabulary, comprising:
receiving a query from a user and processing it to determine if the query uses terms that are outside the predefined vocabulary;
if said query uses terms that are outside the predefined vocabulary, ascertaining words that are related to said terms and then relaxing the query to include at least a subset of said ascertained words that intersect with the predefined vocabulary;
using said words that intersect to query said first search space.

12. The method of claim 11 further comprising:
prompting the user with said subset of said ascertained words and receiving instructions from the user regarding which of said ascertained words to use to query said first search space.

13. The method of claim 11 wherein said step of relaxing the query comprises consulting a second knowledge source to identify words that have a predetermined proximity relationship with the query terms.

14. The method of claim 13 wherein said second knowledge source is a text corpora containing terms that at least partially intersect with the predefined vocabulary of said lexicon.

15. A method of retrieving information from a first search space, comprising:
receiving a query from a user and using the query to obtain first search results from said first search space;
analyzing the first search results based on at least one quality measure;
if the first search results fall below a predetermined level of quality based on said analyzing step, generating a set of alternate query hypotheses by consulting a second knowledge source;
providing said set of hypotheses to the user to select one of said set of hypotheses;
using the user-selected hypothesis to obtain second search results from said first search space.

16. The method of claim 15 wherein said hypothesis is generated using semantic information associated with said first search results.

17. The method of claim 15 wherein said hypothesis is generated using latent semantic indexing.

18. The method of claim 15 wherein said hypothesis is generated using knowledge of recognition scores associated with recognized terms in said first search space.

19. The method of claim 18 wherein recognized terms having low recognition scores are identified and used to generate phonetically related terms to formulate said hypothesis.

20. In an information retrieval system, a method for processing a user's query, comprising:
constructing at least one semantic distance measure associated with said query;
using said semantic distance measure to identify ambiguity associated with said query.

21. The method of claim 20 wherein said semantic distance measure is constructed using latent semantic indexing.

22. The method of claim 20 wherein the user's query contains plural terms and wherein said semantic distance measure is constructed based on said plural terms.

23. The method of claim 20 further comprising retrieving search results based on said query and constructing said semantic distance measure based on said search results retrieved.

24. The method of claim 20 further comprising:
using said semantic distance measure to define centroids associated with results obtained using said query and using said centroids to resolve said ambiguity.

25. The method of claim 20 using said semantic distance measure to define centroids associated with results obtained using said query and using said centroids to resolve said ambiguity by prompting the user to select one of said centroids for use in constructing a second query.

26. In an information retrieval system, a method for processing a user's query, comprising:
constructing a semantic space associated with said query;
resolving ambiguity associated with said query by identifying plural clusters within said semantic space, identifying at least one keyword associated with each cluster and presenting said keywords to the user for selection; and
revising said query based said user selection.

27. A method of identifying phonetically similar word candidates, comprising:
using an automatic speech recognition system to generate a plurality of words from an utterance;
associating a recognition confidence score with each of said words;
using said confidence score to identify phonetically similar word as those words having a confidence score below a predetermined value.

28. In an information retrieval system, a method for processing a user's query, comprising:
from the user's query generating a list of semantically related words;
accessing a search space containing output from an automatic speech recognition process;
using said semantically related words to conduct a query of said search space.

29. The method of claims 1, 11 or 15 wherein said first search space contains output from an automatic speech recognition process upon a news broadcast.

30. The method of claims 1 or 15 wherein said second knowledge source is a news text corpus.
